(19) United States
(12) Patent Application Publication
(10) Pub. No.: US 2026/0192504 A1
(43) Pub. Date: Jul. 9, 2026

(54) SURFACE-FASTENER-MANUFACTURING METHOD AND MOLDING DEVICE

(71) Applicant: YKK Corporation, Tokyo (JP)

(72) Inventors: Takumi Mochizuki, Toyama (JP); Makoto Takekawa, Toyama (JP); Masayuki Naohara, Toyama (JP); Peng Li, Toyama (JP); Hiroyuki Yamashita, Toyama (JP)

(21) Appl. No.: 19/132,671

(22) PCT Filed: Dec. 23, 2022
(86) PCT No.: PCT/JP2022/047644

§ 371 Date: May 23, 2025

(51) Int. Cl. B29C 48/875; A44B 18/00; B29C 48/12; B29C 48/30; B29C 48/50; B29L 31/00

(52) U.S. Cl. CPC B29C 48/875; A44B 18/0049; B29C 48/12; B29C 48/301; B29C 48/501; B29L 2031/729

(57) ABSTRACT

A method of manufacturing a surface fastener includes a molding step of molding at least a base part by feeding molten synthetic resin from a feeding nozzle part to a die wheel that is rotating in one direction. The molding step includes molding the base part in a state where at least one of the feeding nozzle part and the die wheel has a temperature difference between at least two positions that are different in a cross direction, the temperature difference being produced by heating with a heater part. The method enables the manufacture of a surface fastener including a base part whose thickness is uniform or substantially uniform in the width direction and being less likely to have wavy wrinkles even after being wound onto a collecting roller.

### TECHNICAL FIELD

The present invention relates to a surface-fastener-manufacturing method and a molding device.

### BACKGROUND ART

Hitherto known surface fastener products include one provided as a combination of a female surface fastener (hereinafter referred to as a loop member) having a plurality of loops and a male surface fastener attachable to and detachable from the loop member. The male surface fastener includes, for example, a flat base part and a plurality of engaging elements. The engaging elements project from the base part and are each shaped like a mushroom or the like.

Currently, surface fasteners are in wide uses among various products including items to be detachably put on any part of the body: for example, disposable diapers, infant diaper covers, supporters for protecting joints of limbs and the like, waist corsets (belts for lower-back pain), gloves, and so forth. An exemplary surface fastener intended for disposable diapers and the like is disclosed in International Publication No. 2017/109902 (PTL 1).

The surface fastener disclosed in PTL 1 includes a base part and a plurality of engaging elements projecting from the base part. The engaging elements disclosed in PTL 1 each include a stem portion standing from the base part, and a disc-shaped engaging head portion provided integrally with the upper end of the stem portion. The engaging head portion has a plurality of microsized pawl portions projecting from the outer peripheral edge of the engaging head portion.

In the surface fastener disclosed in PTL 1, the microsized pawl portions provided at the engaging head portions of the engaging elements facilitate the engagement of the loops of the loop member with the engaging elements and make it difficult for the loops once engaged to be disengaged from the engaging elements. Thus, an increased peel strength (also referred to as engaging strength) with respect to the loop member is provided to the surface fastener.

As illustrated in FIG. 8, the surface fastener disclosed in PTL 1 is manufactured by using a manufacturing apparatus 80. The manufacturing apparatus 80 includes a molding device 81, which is configured to perform primary molding; and a hot pressing device 91, which is configured to perform secondary molding. The molding device 81 includes a die wheel 82, which is configured to rotate in one direction; a feeding unit 86, which is provided facing the outer peripheral surface of the die wheel 82; and a pickup roller 87, which is provided on the downstream side relative to the feeding unit 86 in the direction of rotation of the die wheel 82.

The die wheel 82 includes a circular cylindrical outer sleeve 83, which serves as a die; a circular cylindrical inner sleeve 84, which is provided on the inner side of and in close contact with the outer sleeve 83; and a rotatable driving roller 85, which is configured to rotate the outer sleeve 83 and the inner sleeve 84 in the one direction. The outer sleeve 83 has a plurality of through-holes each extending through the outer sleeve 83 from the outer peripheral surface to the inner peripheral surface thereof. The inner sleeve 84 has a plurality of recesses in the outer peripheral surface thereof.

The hot pressing device 91 includes a pair of upper and lower pressing rollers (calender rollers) 92 and 93.

To manufacture a surface fastener by using the manufacturing apparatus 80 illustrated in FIG. 8, a primary molding step is first performed by using the molding device 81. In the primary molding step, molten thermoplastic resin is continuously fed from the feeding unit 86 to the rotating die wheel 82, whereby a primary molded body that includes a base part and a plurality of primary elements provided on the base part is molded on the outer peripheral surface of the die wheel 82 in such a manner as to extend in a machining direction. In this step, the base part of the primary molded body is molded between the die wheel 82 and the feeding unit 86, and the primary elements are molded at the through-holes provided in the outer sleeve 83 of the die wheel 82 and the recesses provided in the inner sleeve 84.

Subsequently, the primary molded body thus obtained in the primary molding step is released from the die wheel 82 and is transported to the hot pressing device 91. At the hot pressing device 91, a secondary molding step is performed, in which the primary molded body is introduced between the upper and lower pressing rollers 92 and 93, whereby the upper ends of the primary elements are pressed to be deformed.

Consequently, engaging elements each having an engaging head portion with pawl portions provided at the outer peripheral edge thereof are obtained. Thus, the surface fastener disclosed in PTL 1 is manufactured.

### CITATION LIST

### Patent Literature

PTL 1: International Publication No. 2017/109902

### SUMMARY OF INVENTION

### Technical Problem

In the primary molding step that is performed by using the molding device 81 of the manufacturing apparatus 80 illustrated in FIG. 8, a cooling tank that contains cooling liquid may be provided below the die wheel 82 as a method of cooling the primary molded body molded on the outer peripheral surface of the die wheel 82. The cooling tank is provided such that a lower portion of the die wheel 82 is to be immersed into the cooling liquid. The primary molded body molded on the die wheel 82 is made to pass through the cooling liquid. Thus, the primary molded body can be efficiently cooled.

In the case where, however, a molding device configured to perform the primary molding step and provided with the above cooling tank is used in manufacturing a surface fastener, the surface fastener thus manufactured has thickness variations in the width direction. Specifically, the thickness of the base part is thinner at a central portion thereof in the width direction than at the left and right side-edge portions thereof in the width direction.

If a surface fastener including a base part whose thickness varies as above is collected by being wound onto a collecting roller after the manufacture, the surface fastener wound onto the collecting roller is retained with undulations formed in the base part such that the central portion in the width direction is depressed while the left and right side-edge portions in the width direction are raised. Such a level difference in the base part between the central portion and the left and right side-edge portions in the width direction increases as the length (the number of turns) of the surface fastener that is wound onto the collecting roller increases.

When the surface fastener retained on the collecting roller with the level difference occurring in the width direction as described above is unwound from the collecting roller so as to be used, a problem arises in that the unwound surface fastener may have wrinkles at the left and right side-edge portions of the base part. The wrinkles in the base part are wavy in the upper-lower direction (thickness direction). Such wavy wrinkles affect the quality and performance of the surface fastener and are therefore desired to be solved.

The present invention has been conceived in view of the above problem, and an object of the present invention is to provide a surface-fastener-manufacturing method that enables the manufacture of a surface fastener including a base part whose thickness is uniform in the width direction and being less likely to have wavy wrinkles even after being wound onto to a collecting roller, and to also provide a molding device to be used in the manufacturing method.

### Solution to Problem

To achieve the above object, the present invention provides a surface-fastener-manufacturing method of manufacturing a surface fastener that is made of synthetic resin, the surface fastener including a base part elongated in a machining direction and a plurality of engaging elements provided on the base part, the base part including a base central portion located in a central area in a cross direction that is orthogonal to the machining direction and a pair of base side-edge portions located at two respective end areas in the cross direction. The manufacturing method is characterized by comprising a molding step of molding at least the base part by feeding molten synthetic resin from a feeding nozzle part to a die wheel that is rotating in one direction, the molding step including molding the base part in a state where at least one of the feeding nozzle part and the die wheel has a temperature difference between at least two positions that are different in the cross direction, the temperature difference being produced by heating with a heater part.

In the manufacturing method according to the present invention, it is preferable that the molding step include molding the base part between an outer peripheral surface of the die wheel and a counter surface of the feeding nozzle part, the counter surface facing the die wheel; and producing the temperature difference between a nozzle-side first molding portion of the feeding nozzle part and at least one of a pair of nozzle-side second molding portions of the feeding nozzle part such that a temperature of the nozzle-side second molding portion becomes higher than a temperature of the nozzle-side first molding portion, the nozzle-side first molding portion being configured to mold the base central portion of the base part, the pair of nozzle-side second molding portions being configured to mold the pair of base side-edge portions of the base part.

Furthermore, in the manufacturing method according to the present invention, the molding step may include molding the base part between an outer peripheral surface of the die wheel and a counter surface of the feeding nozzle part, the counter surface facing the die wheel; and producing the temperature difference between a wheel-side first molding portion of the die wheel and at least one of a pair of wheel-side second molding portions of the die wheel such that a temperature of the wheel-side second molding portion becomes higher than a temperature of the wheel-side first molding portion, the wheel-side first molding portion being configured to mold the base central portion of the base part, the pair of wheel-side second molding portions being configured to mold the pair of base side-edge portions of the base part.

Furthermore, it is preferable that the surface-fastener-manufacturing method according to the present invention include making the temperature difference be 20° C. or more.

The present invention also provides a molding device to be used in manufacturing a surface fastener that is made of synthetic resin, the surface fastener including a base part elongated in a machining direction and a plurality of engaging elements provided on the base part, the base part including a base central portion located in a central area in a cross direction that is orthogonal to the machining direction and a pair of base side-edge portions located at two respective end areas in the cross direction. The molding device is configured to mold at least the base part and is characterized by comprising a die wheel configured to rotate in one direction; a feeding nozzle part configured to feed molten synthetic resin to the die wheel; and a heater part configured to heat the feeding nozzle part and/or the die wheel. The feeding nozzle part includes a nozzle-side first molding portion configured to mold the base central portion of the base part; and a pair of nozzle-side second molding portions configured to mold the pair of base side-edge portions of the base part.

The die wheel includes a wheel-side first molding portion configured to mold the base central portion of the base part; and a pair of wheel-side second molding portions configured to mold the pair of base side-edge portions of the base part. The heater part is configured to partially heat at least one of the pair of nozzle-side second molding portions of the feeding nozzle part and/or at least one of the pair of wheel-side second molding portions of the die wheel.

In the molding device according to the present invention, it is preferable that the die wheel and the feeding nozzle part have respective structures configured to mold the base part between an outer peripheral surface of the die wheel and a counter surface of the feeding nozzle part, the counter surface facing the die wheel, and that the heater part include a pair of side heater parts configured to heat the pair of respective nozzle-side second molding portions.

In such a case, it is preferable that at least a portion of each of the side heater parts be located inside the feeding nozzle part.

Furthermore, in the molding device according to the present invention, it is preferable that the feeding nozzle part be made of a metal having a thermal conductivity of 100 W/m·K or less.

### Advantageous Effects of Invention

The manufacturing method according to the present invention enables the manufacture of a surface fastener including a base part whose thickness is uniform or substantially uniform in the width direction and being less likely to have wavy wrinkles even after being wound onto a collecting roller.

### BRIEF DESCRIPTION OF DRAWINGS

FIG. 1 is a schematic diagram of a manufacturing apparatus to be used in a surface-fastener-manufacturing method according to an example of the present invention.

FIG. 2 is a schematic perspective view of a feeding nozzle part included in a primary molding device included in the manufacturing apparatus illustrated in FIG. 1.

FIG. 3 is a schematic sectional view taken along line III-III given in FIG. 1.

FIG. 4 is a schematic perspective view of an outer sleeve and an inner sleeve included in the primary molding device.

FIG. 5 is a schematic perspective view of a primary molded body to be molded in a primary molding step.

FIG. 6 is a schematic perspective view of a surface fastener to be manufactured through the manufacturing method according to the example.

FIG. 7 is a schematic sectional view of part of the surface fastener illustrated in FIG. 6.

FIG. 8 is a schematic diagram of a known surface-fastener-manufacturing apparatus.

### DESCRIPTION OF EMBODIMENTS

A preferred embodiment of the present invention will now be described in detail with reference to the drawings. The present invention is not limited to the following embodiment in any way and may be modified in various ways as long as such modifications provide substantially the same configuration as the present invention and produce similar advantageous effects to the present invention.

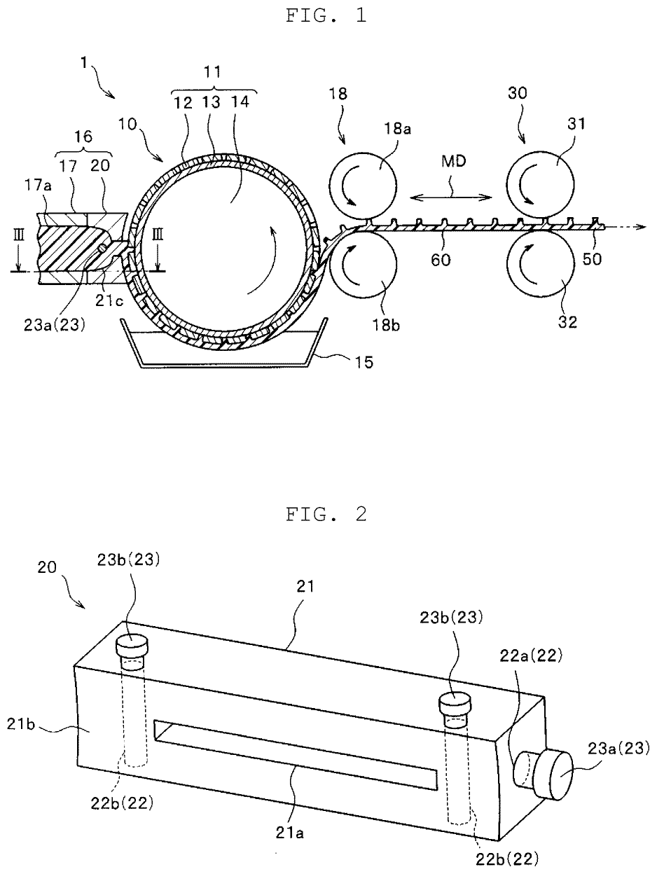

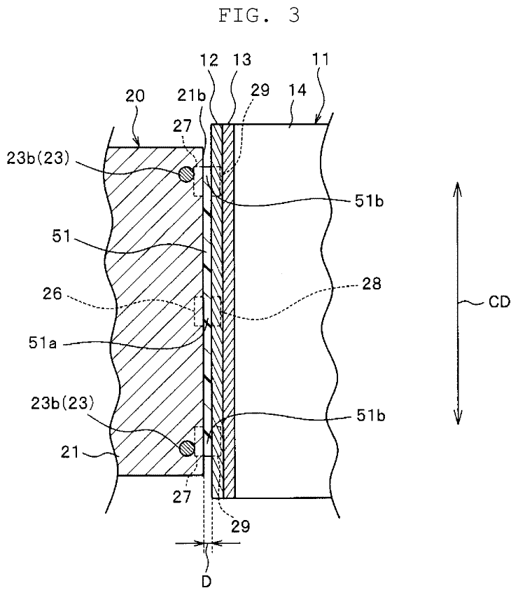

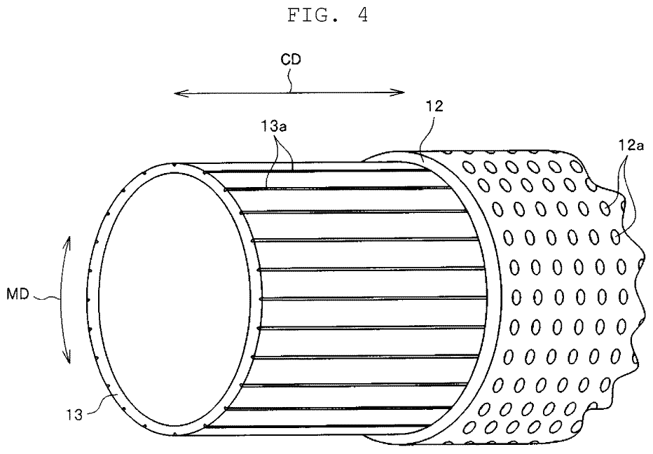

FIG. 1 is a schematic diagram of a manufacturing apparatus to be used in a surface-fastener-manufacturing method according to an example. FIG. 2 is a schematic perspective view of a feeding nozzle part included in a primary molding device. FIG. 3 is a schematic sectional view taken along line III-III given in FIG. 1. FIG. 4 is a schematic perspective view of an outer sleeve and an inner sleeve included in the primary molding device.

In the following description, a machining direction (an M direction or MD) is a direction in which a primary molded body and a surface fastener are to be transported in a process of manufacturing a surface fastener, and is also referred to as the front-rear direction. The machining direction and the front-rear direction are each the length direction of the primary molded body and the surface fastener, which are each molded in an elongated shape.

A cross direction (a C direction or CD) is a width direction that is orthogonal to the machining direction and parallel to the upper surface (first surface) of a base part, and is also referred to as the left-right direction. The cross direction and the left-right direction are each the width direction of the primary molded body and the surface fastener each molded in an elongated shape.

A thickness direction is a direction parallel to a direction orthogonal to the upper surface of the base part, and is also referred to as the upper-lower direction or the height direction. The thickness direction and the upper-lower direction are each a direction orthogonal to both the machining direction and the cross direction. Herein, with reference to the base part, a side toward which engaging elements project is defined as the upper side, and a side opposite the upper side is defined as the lower side.

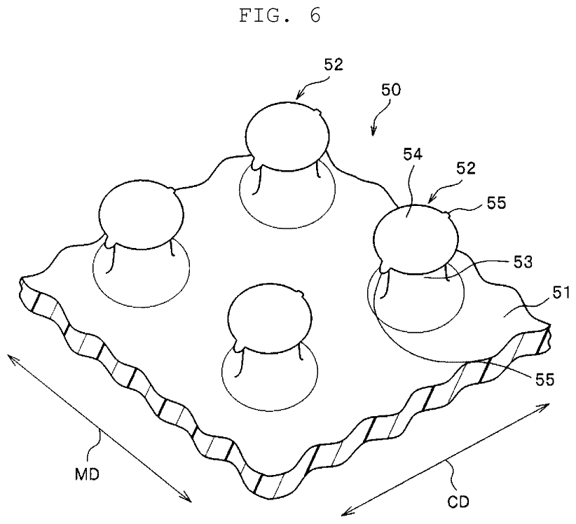

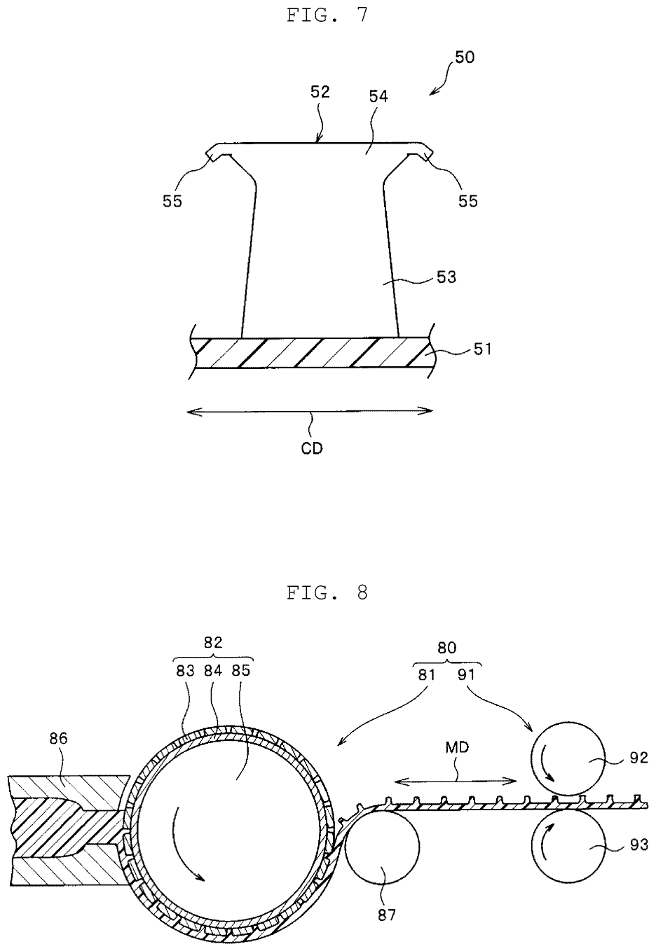

The manufacturing method according to the present embodiment provides a surface fastener 50, which is made of synthetic resin and in which, as illustrated in FIGS. 6 and 7, a plurality of engaging elements 52 are formed integrally with a thin plate-like base part 51 at the upper surface of the base part 51. The surface fastener 50 is elongated in the machining direction MD of the manufacturing apparatus, 1, illustrated in FIG. 1.

The manufacturing apparatus 1 configured to manufacture the surface fastener 50 will now be described with reference to FIGS. 1 to 4.

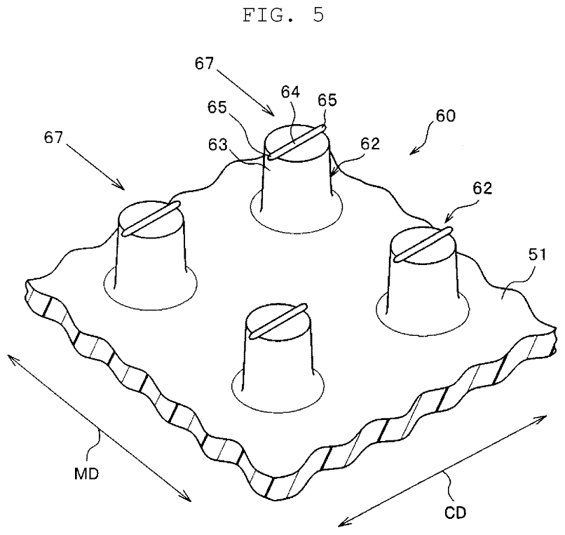

The manufacturing apparatus 1 according to the present embodiment includes a primary molding device 10, which is configured to perform primary molding; and a hot pressing device (secondary molding device) 30, which is configured to perform secondary molding on a primary molded body 60, illustrated in FIG. 5, molded by the primary molding device 10.

The primary molding device 10 includes a die wheel 11, which is configured to rotate in one direction (the counterclockwise direction in the drawing); a resin-feeding unit 16, which is provided facing the outer peripheral surface of the die wheel 11 and is configured to continuously extrude or discharge a molten synthetic resin material; and a pickup roller 18, which is provided on the downstream side relative to the resin-feeding unit 16 in the direction of rotation of the die wheel 11.

The die wheel 11 includes a circular cylindrical outer sleeve 12 (also referred to as an outer cylinder), which serves as a die; a circular cylindrical inner sleeve 13 (also referred to as an inner cylinder), which is provided on the inner side of and in close contact with the outer sleeve 12; and a rotatable driving roller 14, to which the outer sleeve 12 and the inner sleeve 13 are attached. For easy recognition of the structure of the die wheel 11, the section of the rotatable driving roller 14 illustrated in FIGS. 1 and 3 is not hatched.

The die wheel 11 according to the present embodiment is provided with a cooling tank 15. The cooling tank 15 contains cooling liquid and is located below the die wheel 11 such that a portion of the die wheel 11 is to be immersed into the cooling liquid. The rotatable driving roller 14 is configured to cause the outer sleeve 12 and the inner sleeve 13 attached to the rotatable driving roller 14 to rotate in the one direction (the counterclockwise direction in FIG. 1). The rotatable driving roller 14 is provided thereinside with a cooling jacket, which is not illustrated but allows cooling liquid to flow through.

The outer sleeve 12 has, as illustrated in FIG. 4, a plurality of through-holes 12a, which extend through the outer sleeve 12 from the outer peripheral surface to the inner peripheral surface and each serve as a cavity for molding a portion of a primary element 62. The primary element 62 is a part of the primary molded body 60 and will be described separately below. In the present embodiment, for example, synthetic resin is fed into the through-holes 12a of the outer sleeve 12, whereby primary stem portions 63 are molded. The primary stem portions 63 are included in the primary elements 62 and will be described separately below.

In the present embodiment, the plurality of through-holes 12a are arranged in correspondence with the positions of the surface fastener 50 illustrated in FIG. 6 where the engaging elements 52 are to be formed. In the present embodiment, for example, the plurality of through-holes 12a are regularly arranged at constant intervals in the machining direction MD (the peripheral direction of the outer sleeve 12) and are regularly arranged at constant intervals in the cross direction CD (a direction parallel to the rotation axis of the outer sleeve 12).

The through-holes 12a each have a substantially circular truncated conical shape with a circle at the outer peripheral surface of the outer sleeve 12 being greater than a circle at the inner peripheral surface of the outer sleeve 12. In the present invention, the positions, sizes, shapes, and other relevant factors of the plurality of through-holes 12a provided in the outer sleeve 12 are not particularly limited.

The outer peripheral surface of the inner sleeve 13 has a plurality of recessed grooves 13a, which each serve as a cavity for molding portions of the primary element 62 (specifically, a rib portion 64 and projecting portions 65 to be described below). The recessed grooves 13a each linearly extend in the cross direction CD parallel to the rotation axis of the inner sleeve 13 and are each recessed in a size that allows molten synthetic resin to flow in.

The plurality of recessed grooves 13a are arranged at regular intervals in the peripheral direction of the inner sleeve 13 (the machining direction MD). With the die wheel 11 assembled, at least a portion of each of the recessed grooves 13a of the inner sleeve 13 intersects the circular outer peripheral edges of corresponding ones of the through-holes 12a at the inner peripheral surface of the outer sleeve 12.

In the present invention, the form of the recesses provided in the outer peripheral surface of the inner sleeve 13 is not limited to the linear recessed grooves 13a employed in the present embodiment. The recess according to the present invention encompasses, for example, a recessed groove that is bent in a zigzag shape; and a depression that is depressed three-dimensionally in a cuboidal shape or the like relative to the outer peripheral surface of the inner sleeve. Furthermore, in the present invention, the method, means, and the like of making the outer sleeve 12 and the inner sleeve 13 are not specifically limited.

The resin-feeding unit 16 of the primary molding device 10 includes a feeding body part 17 and a feeding nozzle part 20. The feeding nozzle part 20 is connected to a distal end portion of the feeding body part 17. Inside the feeding body part 17 is provided a flow path 17a, through which molten synthetic resin is caused to flow toward the feeding nozzle part 20.

As illustrated in FIG. 2, the feeding nozzle part 20 includes a nozzle body portion 21 and heater parts 23. The nozzle body portion 21 is made of metal and has a feed port 21a, from which synthetic resin is to be ejected. The heater parts 23 are attached to the nozzle body portion 21. The nozzle body portion 21 is made of a metal having a thermal conductivity of 100 W/m·K or less, preferably 70 W/m·K or less. In the present embodiment for example, steel (iron steel), stainless steel, or the like is suitably used as the material for the nozzle body portion 21.

The feed port 21a of the feeding nozzle part 20 is provided at the distal end face (front end face), 21b, of the feeding nozzle part 20. In a front view of the feeding nozzle part 20, the feed port 21a opens in a rectangular shape elongated in the cross direction CD. The distal end face 21b of the feeding nozzle part 20 serves as a counter surface that faces the outer peripheral surface of the die wheel 11. The distal end face 21b is a curved surface that is slightly concave rearward relative to the upper-lower direction. Herein, the front-rear direction of the feeding nozzle part 20 refers to a direction parallel to the direction in which molten synthetic resin flows through the feeding nozzle part 20 toward the feed port 21a. Accordingly, the front side in the front-rear direction is the downstream side in the flow of the synthetic resin, and the rear side is the upstream side in the flow of the synthetic resin. In the present invention, the shape, size, number, and other relevant factors of the feed port 21a of the feeding nozzle part 20 are not limited and may be changed.

The nozzle body portion 21 according to the present embodiment includes a guiding path 21c and three heater-accommodating parts 22. The synthetic resin flowing from the feeding body part 17 is guided along the guiding path 21c to the feed port 21a. The heater-accommodating parts 22 accommodate the respective heater parts 23. The heater-accommodating parts 22 include a first heater-accommodating part 22a, which extends in the cross direction CD; and a pair of left and right second heater-accommodating parts 22b, which each extend in the upper-lower direction. Since the heater-accommodating parts 22 are provided, at least a portion of each of the heater parts 23 can be placed inside the nozzle body portion 21. Thus, the nozzle body portion 21 can be efficiently heated with the heater parts 23.

The heater parts 23 provided to the feeding nozzle part 20 include a cross heater part 23a, which is accommodated in the first heater-accommodating part 22a and therefore extends in the cross direction CD; and a pair of left and right side heater parts 23b, which are accommodated in the respective second heater-accommodating parts 22b and therefore extend in the upper-lower direction. In the present example, the cross heater part 23a and the pair of side heater parts 23b are each a cartridge heater. Furthermore, the cross heater part 23a and the pair of side heater parts 23b are each connected to a temperature controller and are each capable of heating with a temperature that is set by the temperature controller.

The cross heater part 23a extends linearly in the cross direction CD at a central area of the nozzle body portion 21 in the upper-lower direction. The cross heater part 23a is longer than the feed port 21a in the cross direction CD and extends outward in the cross direction CD relative to the positions of the left and right sidewall surfaces of the feed port 21a. Therefore, the cross heater part 23a is capable of heating the entirety or substantially the entirety of the nozzle body portion 21 in the cross direction CD (width direction).

The pair of left and right side heater parts 23b extend linearly in the upper-lower direction at left and right respective side-edge portions of the nozzle body portion 21 (nozzle side-edge portions). More specifically, in the cross direction CD, the left and right side heater parts 23b are each located on the outer side relative to the feed port 21a of the feeding nozzle part 20 and near the feed port 21a. Accordingly, the side heater parts 23b are slightly away from the feed port 21a and the guiding path 21c of the feeding nozzle part 20. Furthermore, in the front-rear direction, the side heater parts 23b are each located near the distal end face 21b of the feeding nozzle part 20 but away from the distal end face 21b of the feeding nozzle part 20. Furthermore, the side heater parts 23b each extend over the entirety or substantially the entirety of the nozzle body portion 21 in the upper-lower direction. Therefore, the left and right side heater parts 23b are capable of partially or locally heating the left and right nozzle side-edge portions at and near the distal end face 21b of the nozzle body portion 21.

Since the above left and right side heater parts 23b are provided, nozzle-side second molding portions 27, to be described below, of the nozzle body portion 21 can be heated to a higher temperature than a nozzle-side first molding portion 26, to be described below, of the feeding nozzle part 20 in a primary molding step (see FIG. 3). In the present invention, the feeding nozzle part may be provided with only one of the left and right side heater parts in the nozzle body portion thereof.

In the present invention, the method and means of heating the nozzle body portion are not particularly limited. For example, the heater part provided to the feeding nozzle part may be located outside the nozzle body portion, not inside the nozzle body portion, in such a manner as to heat the nozzle body portion from the outside. Moreover, the heater part may be any heating means other than the cartridge heater described above, as long as the heater part is capable of heating the nozzle body portion.

The pickup roller 18 of the primary molding device 10 includes a pair of an upper nipping roller 18a and a lower nipping roller 18b, which are configured to nip the primary molded body 60 molded on the outer peripheral surface of the die wheel 11 from above and below and pull the primary molded body 60. The upper nipping roller 18a and the lower nipping roller 18b each have at the outer periphery thereof a surface layer, which is not illustrated but is made of elastomer such as polyurethane elastomer.

The hot pressing device 30 includes a pair of upper and lower pressing rollers (calender rollers) 31 and 32, which are provided on the downstream side relative to the pickup roller 18. The upper pressing roller 31 and the lower pressing roller 32 are positioned facing each other with a predetermined interval therebetween. The interval between the upper pressing roller 31 and the lower pressing roller 32 is adjustable by height-adjusting means, which is not illustrated.

The upper pressing roller 31 includes thereinside a heat source, which is not illustrated. The surface temperature of the upper pressing roller 31 is set to a temperature that softens the synthetic resin to be formed into the surface fastener 50. In the present invention, the configuration of the hot pressing device is not particularly limited as long as the hot pressing device is capable of forming the engaging elements 52 by pressing at least a portion of the primary molded body 60 as to be described below.

Now, a manufacturing method in which a surface fastener 50 is to be manufactured by using the above-described manufacturing apparatus 1 including the primary molding device 10 and the hot pressing device 30 will be described.

The method of manufacturing a surface fastener 50 according to the present embodiment includes a primary molding step of molding a primary molded body 60, such as the one illustrated in FIG. 5, by using the primary molding device 10; and a secondary molding step of molding a plurality of engaging elements 52, such as the ones illustrated in FIGS. 6 and 7, in such a manner as to deform portions of the primary molded body 60 by using the hot pressing device 30.

In the primary molding step, molten synthetic resin is ejected from the feed port 21a of the feeding nozzle part 20 of the resin-feeding unit 16, whereby the synthetic resin is continuously fed from the feeding nozzle part 20 to the outer peripheral surface of the die wheel 11. In the present embodiment, the synthetic resin to be formed into a surface fastener 50 is polypropylene. In the present invention, the kind of the synthetic resin to be formed into the surface fastener is not limited. The material for the surface fastener may be, for example, thermoplastic resin such as polypropylene, polyester, nylon, polybutylene terephthalate, or a copolymer of any of the foregoing.

In this step, the molten synthetic resin to be fed is extruded from the feed port 21a of the feeding nozzle part 20 to the die wheel 11 such that the molten synthetic resin fills the through-holes 12a provided in the outer sleeve 12 of the die wheel 11 and flows into the recessed grooves 13a provided in the inner sleeve 13. Accordingly, the synthetic resin thus extruded from the feed port 21a of the feeding nozzle part 20 flows into the gap between the distal end face 21b of the feeding nozzle part 20 and the outer peripheral surface of the die wheel 11 and overflows to the outer sides in the left-right direction relative to the size of the feed port 21a of the feeding nozzle part 20 (in other words, spreads to areas on the outer sides in the left-right direction relative to the positions of the left and right side edges of the feed port 21a).

With the supply of the molten synthetic resin from the feeding nozzle part 20 to the die wheel 11 as described above, a thin plate-like base part 51 is molded between the curved distal end face 21b of the feeding nozzle part 20 and the outer peripheral surface of the die wheel 11 (specifically, the outer peripheral surface of the outer sleeve 12) (see FIG. 3). In this step, the base part 51 is molded in such a manner as to have a greater dimension in the left-right direction (a greater width dimension) than the feed port 21a of the feeding nozzle part 20. Furthermore, a plurality of primary elements (tentative elements) 62 are molded integrally with the base part 51 by the outer sleeve 12 and the inner sleeve 13 of the die wheel 11 in such a manner as to project from the base part 51.

Furthermore, in the feeding nozzle part 20 according to the present embodiment, the entirety or substantially the entirety of the nozzle body portion 21 in the width direction is heated by the cross heater part 23a. Furthermore, the left and right nozzle side-edge portions of the nozzle body portion 21 are partially heated by the left and right side heater parts 23b. It is preferable that in the left-right direction of the feeding nozzle part 20, the nozzle side-edge portions of the nozzle body portion 21 each include at least the below-described nozzle-side second molding portions 27 of the feeding nozzle part 20, and also include the position of the feeding nozzle part 20 where the left and right side edges of the feed port 21a are located.

In the present embodiment, regarding the base part 51 that is molded between the die wheel 11 and the feeding nozzle part 20, a portion in a central area in the cross direction CD is defined as a base central portion 51a, and portions at two respective end areas in the cross direction CD are defined as base side-edge portions 51b (see FIG. 3). Accordingly, the base part 51 includes a pair of left and right base side-edge portions 51b.

Furthermore, as illustrated in FIG. 3, at and near the distal end face 21b of the feeding nozzle part 20 (nozzle body portion 21), a portion that cooperates with the die wheel 11 to mold the base central portion 51a of the base part 51 is defined as the nozzle-side first molding portion 26, and portions that cooperate with the die wheel 11 to mold the base side-edge portions 51b of the base part 51 are defined as the nozzle-side second molding portions 27. Furthermore, at and near the outer peripheral surface of the die wheel 11, a portion that cooperates with the feeding nozzle part 20 to mold the base central portion 51a of the base part 51 is defined as a wheel-side first molding portion 28, and portions that cooperate with the feeding nozzle part 20 to mold the base side-edge portions 51b of the base part 51 are defined as wheel-side second molding portions 29.

Accordingly, in the feeding nozzle part 20 according to the present embodiment, the side heater parts 23b provided to the nozzle body portion 21 partially heat the left and right nozzle side-edge portions including the nozzle-side second molding portions 27 of the nozzle body portion 21. Thus, the temperature of the feeding nozzle part 20 can be made to vary in the cross direction CD.

Consequently, a temperature difference can be intentionally produced between two positions of the feeding nozzle part 20 that are different in the cross direction CD: for example, between a position near each of the side heater parts 23b and a position away from the side heater parts 23b in the cross direction CD. Furthermore, in the present embodiment, the nozzle body portion 21 of the feeding nozzle part 20 is made of a metal exhibiting a low thermal conductivity of 100 W/m·K or less as described above. That is, heat is less conductive in the nozzle body portion 21, which makes it easier to produce the temperature difference in the cross direction CD. Accordingly, in the process of molding the base part 51 by using the primary molding device 10, a temperature difference between the nozzle-side first molding portion 26 and each of the left and right nozzle-side second molding portions 27 can be stably produced at and near the distal end face 21b of the nozzle body portion 21 such that the temperature of the nozzle-side second molding portions 27 becomes higher than the temperature of the nozzle-side first molding portion 26.

Here, the problem in the known surface-fastener-manufacturing method will be discussed again. In the known manufacturing method in which the primary molding step is performed while a lower portion of the die wheel is immersed in the cooling liquid contained in the cooling tank so that the primary molded body is cooled, the base part of the surface fastener thus manufactured has thickness variations in the width direction (cross direction CD) as described above. Consequently, when the surface fastener thus manufactured is collected onto a collecting roller and is then unwound from the collecting roller so as to be used, a problem arises in that the unwound surface fastener has wavy wrinkles. The present inventors have repeatedly conducted thorough examinations on the problem in the known art. As a result, the following has been found.

In the process of molding a primary molded body 60 on the outer peripheral surface of the die wheel 11, as is apparent from FIG. 3 for example, the outer peripheral surface of the die wheel 11 typically has two kinds of areas: an area that is covered with the base part 51 of the primary molded body 60, and areas that are located on the outer sides in the cross direction CD and are not covered with the base part 51. Therefore, in the case where the primary molding step is performed while the die wheel 11 is immersed in the cooling liquid, some of the cooling liquid adheres to the outer-side areas (the areas that are not covered with the base part 51) of the outer peripheral surface of the rotating die wheel 11 and is carried to the position of the feeding nozzle part with the rotation of the die wheel 11. Furthermore, the cooling liquid thus carried to the position of the feeding nozzle part touches the nozzle-side second molding portions and areas therearound at the distal end face (front end face) of the feeding nozzle part.

Regarding the known manufacturing method, it has been found that since the cooling water in the cooling tank adheres to or touches areas of the outer peripheral surface of the die wheel that are on the outer sides in the cross direction and also adheres to or touches the nozzle-side second molding portions and areas therearound at the distal end face of the feeding nozzle part as described above, the temperatures of such areas where the cooling water adheres or touches are lowered, which leads to a difference in thermal expansion in each of the feeding nozzle part and the die wheel between the area where the cooling water adheres or touches and the area where the cooling water neither adheres nor touches (that is, between positions that are different in the cross direction CD). Therefore, in the known primary molding step, the above difference in thermal expansion causes a phenomenon in which the interval between the distal end face of the feeding nozzle part and the outer peripheral surface of the die wheel varies in the cross direction. Such a variation in the interval between the feeding nozzle part and the die wheel due to the difference in thermal expansion has been identified as one of the causes for the thickness variations in the base part that occur in the width direction (cross direction).

In view of the above problem in the known art, the present embodiment employs the side heater parts 23b provided to the feeding nozzle part 20. During the primary molding step, the left and right nozzle-side second molding portions 27 of the nozzle body portion 21 and areas therearound are heated by using the side heater parts 23b. Thus, as described above, the temperature difference between the nozzle-side first molding portion 26 and the left and right nozzle-side second molding portions 27 is actively produced at and near the distal end face 21b of the nozzle body portion 21 such that the temperature of the nozzle-side second molding portions 27 becomes higher than the temperature of the nozzle-side first molding portion 26.

In the present embodiment particularly, a temperature difference of 20° C. or more is produced between the nozzle-side first molding portion 26 and the left and right nozzle-side second molding portions 27 that are heated by the heater parts 23. Note that the temperature of the nozzle-side first molding portion 26 and the temperature of the nozzle-side second molding portions 27 each refer to the actual temperature of a corresponding portion that is measured by a temperature sensor or the like.

Since the above temperature difference is produced in the nozzle body portion 21, the nozzle-side second molding portions 27 can be made to expand more than the nozzle-side first molding portion 26. Therefore, in the primary molding step, even if cooling liquid adheres to or touches the outer peripheral surface of the die wheel 11 at the areas that are on the outer sides in the cross direction CD and at and near the nozzle-side second molding portions 27 of the distal end face 21b of the feeding nozzle part 20, the interval, D, between the distal end face 21b of the feeding nozzle part 20 and the outer peripheral surface of the die wheel 11 is less likely to vary in the cross direction CD.

In the present invention, the degree of temperature difference to be produced between the nozzle-side first molding portion 26 and the nozzle-side second molding portions 27 of the nozzle body portion 21 so as to reduce the variation in the interval D that occurs in the cross direction CD is not particularly limited, and may be set to an appropriate temperature difference in correspondence with, for example, the shape and size of the nozzle body portion 21, the material of the nozzle body portion 21, and the like. In the present embodiment for example, a temperature difference of 20° C. or more is produced as described above, whereby the variation in the interval D that occurs in the cross direction CD can be effectively reduced. Furthermore, it is preferable that the temperature difference to be produced between the nozzle-side first molding portion 26 and the left and right nozzle-side second molding portions 27 be 35° C. or less. Such a setting reduces the probability that the interval D between the distal end face 21b of the feeding nozzle part 20 and the outer peripheral surface of the die wheel 11 may vary in the cross direction CD because of excessive expansion of the nozzle-side second molding portions 27 of the feeding nozzle part 20 under the heat of the side heater parts 23b.

Hence, in the primary molding step according to the present embodiment, the use of the primary molding device 10 in which a temperature difference in the cross direction CD is produced in the nozzle body portion 21 of the feeding nozzle part 20 enables stable molding of a primary molded body 60, such as the one illustrated in FIG. 5, that includes a thin plate-like base part 51 with a small thickness variation in the cross direction CD (width direction) and a plurality of primary elements (tentative elements) 62 formed integrally with the base part 51 and projecting from the upper surface of the base part 51.

The plurality of primary elements 62 included in the primary molded body 60 in such an embodiment are portions that are to undergo secondary molding (press molding) in the secondary molding step so as to be deformed into respective engaging elements 52. In the present embodiment, the plurality of primary elements 62 are regularly arranged on the upper surface of the base part 51 in a grid pattern in which the primary elements 62 are arrayed in the machining direction MD and in the cross direction CD. In such an arrangement, the primary elements 62 are at regular pitches (intervals) in the machining direction MD, thereby forming element rows 67. Furthermore, a plurality of such element rows 67 are arranged at regular intervals in the cross direction CD. Therefore, the plurality of engaging elements 52 molded from the primary elements 62 are also regularly arranged in a grid pattern.

In the present invention, factors such as the number, size (width and height), arrangement pattern, and arrangement density of the primary elements and the engaging elements are not particularly limited and may be changed. For example, the primary elements and the engaging elements may be arranged in a staggered pattern in which the primary elements or the engaging elements are positioned alternately or in a zigzag manner with the element rows that are adjacent to each other in the cross direction being shifted relative to each other in the machining direction MD by ½ of the pitch of the primary elements or engaging elements.

In the present embodiment, the primary elements 62 each include a primary stem portion 63, which has a circular truncated conical shape standing from the base part 51; a stick-like rib portion 64, which is a portion of the upper surface of the primary stem portion 63 that is raised upward; and two projecting portions (primary pawl portions) 65, which are formed integrally with the rib portion 64 and project from two respective ends of the rib portion 64. In such a configuration, the rib portion 64 and the projecting portions 65 of each of the primary elements 62 are aligned in the cross direction CD (the direction in which the recessed grooves 13a extend). Furthermore, in a plan view of the primary element 62, the projecting portions 65 each project outward relative to the upper end face of the primary stem.

In the primary molding step according to the present embodiment, while the molten synthetic resin on the outer peripheral surface of the die wheel 11 undergoes half a rotation, the molten synthetic resin is cooled and hardened in the cooling tank 15 containing cooling liquid and by the cooling jacket provided inside the rotatable driving roller 14. Thus, the above-described primary molded body 60 is molded. Then, the primary molded body 60 is continuously released from the outer peripheral surface of the die wheel 11 by the pickup roller 18.

Subsequently, the primary molded body 60 released from the die wheel 11 is transported toward the hot pressing device 30 configured to perform the secondary molding step and is introduced between the upper pressing roller 31 and the lower pressing roller 32 of the hot pressing device 30. In the secondary molding step, the base part 51 of the primary molded body 60 is supported from below by the lower pressing roller 32. Furthermore, at least the upper ends of the primary elements 62 of the primary molded body 60 are heated to be softened and are pressed from above by the upper pressing roller 31. Thus, a plurality of engaging elements 52 such as the ones illustrated in FIGS. 6 and 7 are molded integrally with the upper surface of the base part 51.

The engaging elements 52 that are molded in the secondary molding step each include a stem portion 53, which has a substantially circular truncated conical shape standing from the base part 51; an engaging head portion 54, which is formed integrally with the upper end of the stem portion 53; and two microsized pawl portions (engaging pawl portions) 55, which each project outward from the outer peripheral edge of the engaging head portion 54. The engaging head portion 54 spreads generally outwardly in a direction orthogonal to the thickness direction relative to the upper end (distal end part) of the stem portion 53. In a plan view (not illustrated) of the engaging element 52 that is seen from above, the two pawl portions 55 each project in the cross direction CD from the engaging head portion 54.

In the present invention, the shape and size of the engaging elements are not particularly limited. For example, factors such as the shape of the meshing head portion, the shape of the pawl portions, the number of the pawl portions, and the direction in which the pawl portions project from the engaging head may be changed to form the engaging elements. Furthermore, a single surface fastener may include engaging elements of a plurality of kinds with respectively different shapes.

The surface fastener 50 having passed through the upper pressing roller 31 and the lower pressing roller 32 is then delivered from the hot pressing device 30 and is collected by being wound into a roll on, for example, a collecting roller or the like. Alternatively, the surface fastener 50 may be collected after being transported from the hot pressing device 30 to a cutting unit, not illustrated, and being cut by the cutting unit into pieces each having a predetermined width dimension and/or length dimension. Furthermore, the surface fastener 50 delivered from the hot pressing device 30 may be subjected to any other processing operation, such as a drawing process of drawing the surface fastener 50 in the machining direction MD, before being collected onto the collecting roller or the like.

To summarize, through the manufacturing method according to the present embodiment including the primary molding step and the secondary molding step, the surface fastener 50 illustrated in FIGS. 6 and 7 is obtained.

In the surface fastener 50 manufactured in accordance with the present embodiment, as described above, the thickness of the base part 51 between the upper surface and the lower surface thereof is less likely to vary in the width direction than in the case of the known manufacturing method. That is, the base part 51 is formed with a thickness that is substantially the same between the central portion in the width direction and the left and right side-edge portions in the width direction. Thus, a surface fastener 50 including a base part 51 whose thickness is uniform or substantially uniform in the width direction can be obtained.

Accordingly, even when the surface fastener 50 is wound onto and retained on a collecting roller after the manufacture, the base part 51 of the surface fastener 50 thus wound is prevented from having or is less likely to have such undulations that the central portion thereof in the width direction is depressed while the left and right side-edge portions thereof in the width direction are raised as in the known art. Hence, even when the surface fastener 50 collected onto the collecting roller is unwound afterwards from the collecting roller, no wavy wrinkles occur at the left and right side-edge portions of the base part 51. Thus, the quality and performance of the surface fastener 50 can be stably maintained during the manufacture.

In the above embodiment, the nozzle body portion 21 of the feeding nozzle part 20 is provided with a pair of side heater parts 23b. Alternatively, in the present invention, wheel heater parts configured to partially heat the pair of wheel-side second molding portions 29 of the die wheel 11 may be provided to, for example, the rotatable driving roller 14 of the die wheel 11 in replacement of the side heater parts 23b provided to the feeding nozzle part 20 or in addition to the side heater parts 23b provided to the feeding nozzle part 20.

If such wheel heater parts are provided, a temperature difference (for example, a temperature difference of 20° C. or more) can be produced in the outer sleeve 12 and the inner sleeve 13 of the die wheel 11 between the wheel-side first molding portion 28 and the left and right wheel-side second molding portions 29 such that the temperature of the wheel-side second molding portions 29 becomes higher than the temperature of the wheel-side first molding portion 28 (see FIG. 3).

Such a temperature difference can expand the wheel-side second molding portions 29 more than the wheel-side first molding portion 28. Therefore, in the primary molding step, even if cooling liquid adheres to or touches the die wheel 11 and the feeding nozzle part 20, the interval D between the distal end face 21b of the feeding nozzle part 20 and the outer peripheral surface of the die wheel 11 is less likely to vary in the cross direction CD. Thus, a surface fastener 50 including a base part 51 whose thickness is uniform or substantially uniform in the width direction can be manufactured.

If wheel heater parts configured to heat the die wheel 11 are provided, the wheel heater parts may be provided outside the die wheel 11, not to the above-described rotatable driving roller 14, so that the wheel-side second molding portions 29 of the die wheel 11 are heated from the outside.

In the primary molding device 10 according to the above embodiment, molten synthetic resin is fed from the feeding nozzle part 20 to the die wheel 11, whereby the base part 51 is molded between the distal end face 21b of the feeding nozzle part 20 and the outer peripheral surface of the die wheel 11. In the present invention, the primary molding device may alternatively be configured to feed a molten synthetic resin material from, for example, the feeding nozzle part to the gap between two die wheels provided face to face at the respective outer peripheral surfaces (that is, a twin-wheel structure). In such a configuration, the base part 51 is to be molded between the pair of die wheels, and the plurality of primary elements 62 are to be molded by the outer sleeve and the inner sleeve of one of the die wheels. In such a case as well, one of or both of the die wheels may be provided with wheel heater parts configured to heat the wheel-side second molding portions. Thus, a surface fastener including a base part whose thickness is uniform or substantially uniform in the width direction can be manufactured.

In the above embodiment, the cooling tank 15 is provided below the die wheel 11, and the pair of side heater parts 23b are provided to the feeding nozzle part 20 so as to reduce the variation in the thickness of the base part 51 that may be caused by the cooling water in the cooling tank 15. The present invention, however, is also applicable to a case where the surface fastener is manufactured without using the cooling tank 15 in molding the primary molded body.

For example, in a case where a primary molding device according to a modification that is obtained with an omission of the cooling tank 15 from the primary molding device 10 according to the above embodiment is used in molding the primary molded body 60, a difference in thermal expansion may occur through air cooling between an area of the outer peripheral surface of the die wheel that is covered with the base part 51 and areas of the outer peripheral surface of the die wheel that are on the outer sides and are not covered with the base part 51. Furthermore, at the distal end face of the feeding nozzle part, since the nozzle-side second molding portions are air-cooled from the outer sides in the width direction, a difference in thermal expansion may occur between the nozzle-side second molding portions and the nozzle-side first molding portion. Therefore, even with the primary molding device according to the modification that does not include the cooling tank 15, if side heater parts are provided to the feeding nozzle part and/or wheel heater parts are provided to the die wheel, the thickness of the base part 51 of the surface fastener 50 can be made much less likely to vary in the width direction so that the thickness of the base part 51 becomes uniform.

In the above embodiment, the surface fastener 50 is manufactured through the primary molding step performed with the use of the primary molding device 10 and the secondary molding step performed with the use of the hot pressing device 30. In the present invention, the surface fastener 50 may alternatively be manufactured without the secondary molding step according to the above embodiment but through, for example, a molding step performed with the use of a molding device including a die wheel having cavities with which engaging elements 52 each including a stem portion 53 and an engaging head portion 54 are moldable.

### REFERENCE SIGNS LIST

1 manufacturing apparatus
10 primary molding device
11 die wheel
12 outer sleeve (outer cylinder)
12a through-hole
13 inner sleeve (inner cylinder)
13a recessed groove
14 rotatable driving roller
15 cooling tank
16 resin-feeding unit
17 feeding body part
17a flow path
18 pickup roller
18a upper nipping roller
18b lower nipping roller
20 feeding nozzle part
21 nozzle body portion
21a feed port
21b distal end face (front end face)
21c guiding path
22 heater-accommodating part
22a first heater-accommodating part
22b second heater-accommodating part
23 heater part
23a cross heater part
23b side heater part
26 nozzle-side first molding portion
27 nozzle-side second molding portion
28 wheel-side first molding portion
29 wheel-side second molding portion
30 hot pressing device (secondary molding device)
31 upper pressing roller (calender roller)
32 lower pressing roller (calender roller)
50 surface fastener
51 base part
51a base central portion
51b base side-edge portion
52 engaging element
53 stem portion
54 engaging head portion
55 pawl portion (engaging pawl portion)
60 primary molded body
62 primary element (tentative element)
63 primary stem portion
64 rib portion
65 projecting portion (primary pawl portion)
67 element row
D interval between distal end face of feeding nozzle part and outer peripheral surface of die wheel
CD cross direction
MD machining direction

1. A surface-fastener-manufacturing method of manufacturing a surface fastener that is made of synthetic resin, the surface fastener including a base part elongated in a machining direction and a plurality of engaging elements provided on the base part, the base part including a base central portion located in a central area in a cross direction that is orthogonal to the machining direction and a pair of base side-edge portions located at two respective end areas in the cross direction, the manufacturing method comprising:
a molding step of molding at least the base part by feeding molten synthetic resin from a feeding nozzle part to a die wheel that is rotating in one direction,
the molding step including molding the base part in a state where at least one of the feeding nozzle part and the die wheel has a temperature difference between at least two positions that are different in the cross direction, the temperature difference being produced by heating with a heater part.

2. The surface-fastener-manufacturing method according to claim 1, wherein
the molding step includes molding the base part between an outer peripheral surface of the die wheel and a counter surface of the feeding nozzle part, the counter surface facing the die wheel; and producing the temperature difference between a nozzle-side first molding portion of the feeding nozzle part and at least one of a pair of nozzle-side second molding portions of the feeding nozzle part such that a temperature of the nozzle-side second molding portion becomes higher than a temperature of the nozzle-side first molding portion, the nozzle-side first molding portion being configured to mold the base central portion of the base part, the pair of nozzle-side second molding portions being configured to mold the pair of base side-edge portions of the base part.

3. The surface-fastener-manufacturing method according to claim 1, wherein
the molding step includes molding the base part between an outer peripheral surface of the die wheel and a counter surface of the feeding nozzle part, the counter surface facing the die wheel; and producing the temperature difference between a wheel-side first molding portion of the die wheel and at least one of a pair of wheel-side second molding portions of the die wheel such that a temperature of the wheel-side second molding portion becomes higher than a temperature of the wheel-side first molding portion, the wheel-side first molding portion being configured to mold the base central portion of the base part, the pair of wheel-side second molding portions being configured to mold the pair of base side-edge portions of the base part.

4. The surface-fastener-manufacturing method according to claim 1 comprising:
making the temperature difference be 20° C. or more.

5. A molding device to be used in manufacturing a surface fastener that is made of synthetic resin, the surface fastener including a base part elongated in a machining direction and a plurality of engaging elements provided on the base part, the base part including a base central portion located in a central area in a cross direction that is orthogonal to the machining direction and a pair of base side-edge portions located at two respective end areas in the cross direction, the molding device being configured to mold at least the base part and comprising:
a die wheel configured to rotate in one direction; a feeding nozzle part configured to feed molten synthetic resin to the die wheel; and a heater part configured to heat the feeding nozzle part and/or the die wheel,
the feeding nozzle part including a nozzle-side first molding portion configured to mold the base central portion of the base part; and a pair of nozzle-side second molding portions configured to mold the pair of base side-edge portions of the base part,
the die wheel including a wheel-side first molding portion configured to mold the base central portion of the base part; and a pair of wheel-side second molding portions configured to mold the pair of base side-edge portions of the base part,
the heater part being configured to partially heat at least one of the pair of nozzle-side second molding portions of the feeding nozzle part and/or at least one of the pair of wheel-side second molding portions of the die wheel.

6. The molding device according to claim 5, wherein
the die wheel and the feeding nozzle part have respective structures configured to mold the base part between an outer peripheral surface of the die wheel and a counter surface of the feeding nozzle part, the counter surface facing the die wheel, and
the heater part includes a pair of side heater parts configured to heat the pair of respective nozzle-side second molding portions.

7. The molding device according to claim 6, wherein
at least a portion of each of the side heater parts is located inside the feeding nozzle part.

8. The molding device according to claim 5, wherein
the feeding nozzle part is made of a metal having a thermal conductivity of 100 W/m·K or less.
